(19) United States
(12) Patent Application Publication
(10) Pub. No.: US 2014/0191980 A1
(43) Pub. Date: Jul. 10, 2014

(54) SYSTEM FOR REUSE OF TOUCH PANEL AND CONTROLLER BY A SECONDARY DISPLAY

(71) Applicant: QUALCOMM MEMS TECHNOLOGIES, INC., San Diego, CA (US)

(72) Inventors: Pavankumar Mulabagal, San Jose, CA (US); Vaidyanathan Pallavur Ramasarma, San Diego, CA (US); Mithran Cheriyan Mathew, Mountain View, CA (US)

(73) Assignee: QUALCOMM MEMS Technologies, Inc., San Diego, CA (US)

(21) Appl. No.: 13/753,235

(22) Filed: Jan. 29, 2013

Related U.S. Application Data
(60) Provisional application No. 61/748,862, filed on Jan. 4, 2013.

(51) Int. Cl. G06F 3/041

(52) U.S. Cl. CPC G06F 3/041
USPC 345/173

(57) ABSTRACT

This disclosure provides systems, methods and apparatus, including computer programs encoded on computer storage media, for controlling a display device that includes a first display, a touch screen disposed on the first display and a second display. In one aspect, the first display may be disposed on a first side of the display device (e.g., the front side) and the second display may be disposed on a second side of the display device (e.g., the back side). The second display may consume less power than the first display. Even when the first display is switched off, a control system may be configured to control the second display in response to input received from the touch screen disposed on the first display. The control system may be further configured to control the first display in response to input received from the touch screen when the first display is switched on or when the second display is not in use.

### CROSS-REFERENCE TO RELATED APPLICATION

This application claims benefit under 35 U.S.C. §119(e) to U.S. Provisional Patent Application No. 61/748,862, titled “DISPLAY DEVICES HAVING A PRIMARY DISPLAY AND A SECONDARY DISPLAY,” filed Jan. 4, 2013 (Attorney Docket Number QUALP182P1US/124423P1), which is incorporated by reference herein in its entirety and for all purposes.

### TECHNICAL FIELD

This disclosure relates to display systems and devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Smartphones and other portable display devices continue to gain popularity. Consumers want a small overall device size, with as large a display as possible. In order to maximize the display area, it may be desirable to increase the amount of surface area of the device on which a display is provided. Minimizing a display border area size can be part of the solution. However, it may be may be desirable to provide displays on more than one side of a device.

Accordingly, some portable display devices may have a first or primary display and at least one other display, which will be referred to herein as a second or secondary display. Consumers currently expect that every display will have an associated touch panel (also referred to herein as a “touch screen”). For a device that includes a primary display and a secondary display, one way of meeting this expectation would be simply to dispose a separate touch panel on each display, either by mounting a touch panel on the display or by incorporating a touch panel in the display glass of each display.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus that includes a first display, a touch screen disposed on the first display, a second display and a control system. The control system may be configured to control the second display in response to input received from the touch screen, even when the first display is powered off. In some implementations, the control system may be configured to switch the first display off when controlling the second display in response to input received from the touch screen.

In some implementations, the first display may be disposed on a first side of the apparatus and the second display may be disposed on a second side of the apparatus. The first side may be on an opposite side of the apparatus relative to the second side.

In some implementations, the second display may consume less power than the first display. The second display may be a reflective display, such as an interferometric modulator (“IMOD”) display. The first display may be an emissive display or a transmissive display.

The control system may be further configured to control the first display in response to input received from the touch screen when the first display is switched on or when the second display is not in use. In some implementations, the control system may include a higher-power processor core. The control system may be further configured to turn the higher-power processor core on or off according to a type of application that is being used to control the second display. The control system also may include a lower-power processor core. The control system may be further configured to determine whether to use the higher-power processor core or the low-power processor core to control at least part of the apparatus.

In some implementations, the apparatus may include a motion sensor. The control system may be further configured to activate the touch screen if the control system receives an indication from the motion sensor that the apparatus has been moved from a stationary position. Alternatively, or additionally, the control system may be configured to deactivate the touch screen if the control system receives no indication that the apparatus has been moved, or that the touch screen has been used, for a period of time.

In some implementations, the apparatus may include an orientation sensor. The control system may be further configured to activate or deactivate the first display according to input from the orientation sensor.

In some implementations, the control system may be configured to process image data. The control system may include a driver circuit configured to send at least one signal to at least one of the first display or the second display and a controller configured to send at least a portion of the image data to the driver circuit. The control system may include an image source module configured to send the image data to the processor. The image source module may include a receiver, a transceiver and/or a transmitter. The apparatus may include an input device configured to receive input data and to communicate the input data to the control system.

In some implementations, the size of the touch screen may be different from the size of the second display. The control system may be further configured to map touch screen areas to second display areas.

The control system may include at least one of a general purpose single- or multi-chip processor, a digital signal processor (DSP), an application specific integrated circuit (ASIC), a field programmable gate array (FPGA) or other programmable logic device, discrete gate or transistor logic, or discrete hardware components. In some implementations, the control system may include a “system on a chip” that includes the general purpose single- or multi-chip processor and one or more of the DSP, ASIC, FPGA or other programmable logic device, discrete gate or transistor logic, or discrete hardware components.

Another innovative aspect of the subject matter described in this disclosure can be implemented in a method that involves receiving input from a touch screen disposed on a first display of a display device and controlling a second display of the display device in response to the input. The controlling process may be performed even when the first display is powered off.

The display device may include a higher-power processor core. The method may involve determining a type of application that is being used to control the second display and turning the higher-power processor core on or off according to the type of application. The display device also may include a low-power processor core. The method may involve determining whether to use the higher-power processor core or the low-power processor core to control at least part of the display device.

The display device also may include a motion sensor. The method may involve activating the touch screen if the motion sensor indicates that the display device has been moved from a stationary position.

The display device also may include an orientation sensor. The method may involve activating or deactivating the first display according to input from the orientation sensor.

The second display may or may not be the same size as the touch screen. The method may involve mapping touch screen areas to second display areas. In some implementations, the first display may be on an opposite side of the display device relative to the second display.

Another innovative aspect of the subject matter described in this disclosure can be implemented in a non-transitory medium having instructions for the following processes stored thereon: receiving input from a touch screen disposed on a first display of a display device; and controlling a second display of the display device in response to the input, wherein the controlling process may be performed even when the first display is powered off.

In some implementations, the display device may include a higher-power processor core. The non-transitory medium may include instructions for determining a type of application that is being used to control the second display and for turning the higher-power processor core on or off according to the type of application. In some implementations, the display device may include a low-power processor core and a higher-power processor core. The non-transitory medium may include instructions for determining whether to use the higher-power processor core or the low-power processor core to control at least part of the display device.

In some implementations, the display device may include a motion sensor. The non-transitory medium may include instructions for activating the touch screen if the motion sensor indicates that the display device has been moved from a stationary position. The display device may include an orientation sensor. The non-transitory medium may include instructions for activating or deactivating the first display according to input from the orientation sensor.

The second display may or may not be the same size as the touch screen, depending on the particular implementation. The non-transitory medium may include instructions for mapping touch screen areas to second display areas.

Details of one or more implementations of the subject matter described in this disclosure are set forth in the accompanying drawings and the description below. Although the examples provided in this disclosure are primarily described in terms of EMS and MEMS-based displays, the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a graph illustrating movable reflective layer position versus applied voltage for an IMOD display element.

FIG. 4 is a table illustrating various states of an IMOD display element when various common and segment voltages are applied.

FIG. 5A is an illustration of a frame of display data in a three element by three element array of IMOD display elements displaying an image.

FIG. 5B is a timing diagram for common and segment signals that may be used to write data to the display elements illustrated in FIG. 5A.

FIGS. 6A and 6B show an example of a display device having a first display and a second display.

FIG. 6C shows an example of a user interacting with a touch screen.

FIG. 7A is a block diagram that shows components of a display device 600 according to one implementation.

FIG. 7B is a block diagram that shows components of a display device 600 according to an alternative implementation.

FIG. 8 is a flow diagram that outlines a method of controlling a display device.

FIG. 9 is a flow diagram that outlines an alternative method of controlling a display device.

FIG. 10 is a flow diagram that outlines another method of controlling a display device.

FIG. 11 is a flow diagram that outlines a method of controlling a display device according to use indicia.

FIGS. 12A and 12B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, a display device may include a first display, a touch screen disposed on the first display, a second display and a control system. In some implementations, no touch screen is disposed on the second display. The first display may be disposed on a first side of the display device (which may be referred to herein as the front side) and the second display may be disposed on a second side of the display device (which may be referred to herein as the back side). The second display may, for example, be a reflective display that consumes less power than the first display. Even when the first display is switched off, the control system may be configured to control the second display in response to input received from the touch screen disposed on the first display. The control system may be further configured to control the first display in response to input received from the touch screen when the first display is switched on or when the second display is not in use.

Particular implementations of the subject matter described in this disclosure can be implemented to realize one or more of the following potential advantages. Having one touch panel and a shared controller may be more cost-effective than using two sets of touch panels and controllers. Moreover, having one touch panel and a shared controller can decrease the overall weight, thickness and/or size of the device and may result in lower power consumption, particularly when the first display is switched off. Reducing the number of layers on the second display may increase the transmissivity of the second display and may improve the contrast and image quality of the second display compared to a secondary display with an overlying touch panel.

An example of a suitable EMS or MEMS device or apparatus, to which the described implementations may apply, is a reflective display device. Reflective display devices, such as devices that include a second display as described herein, can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

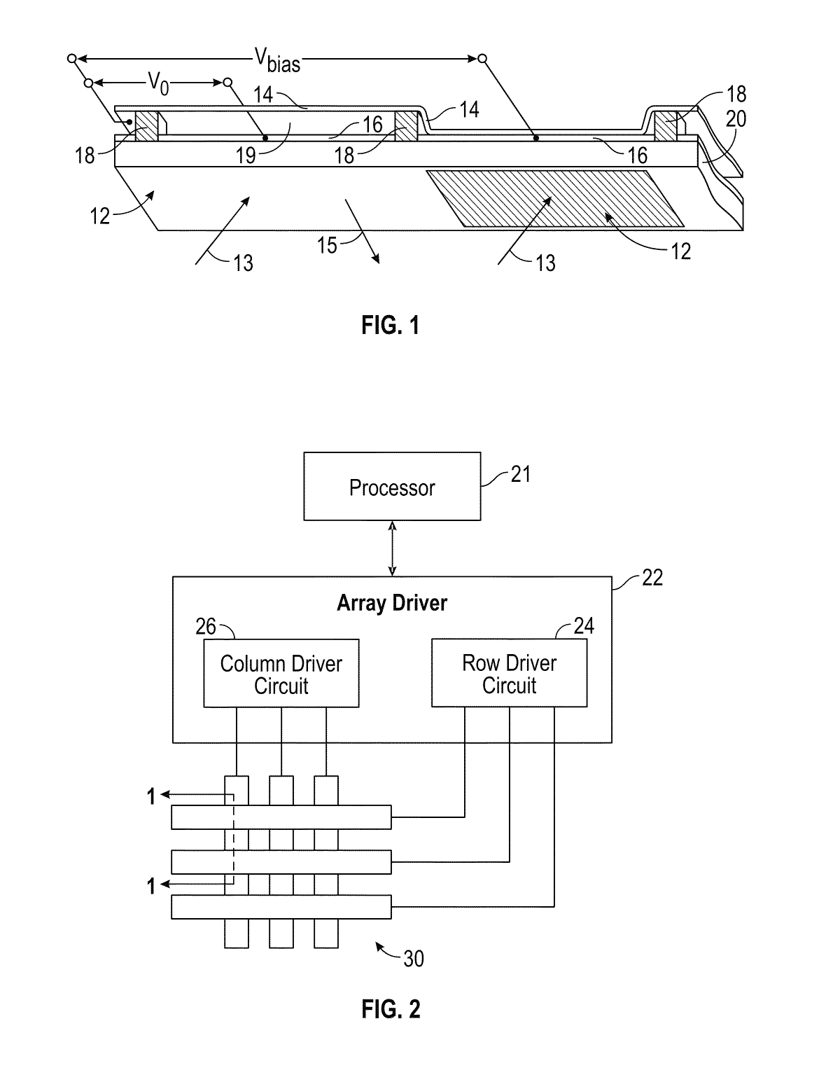

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated, depending on a targeted gap height. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

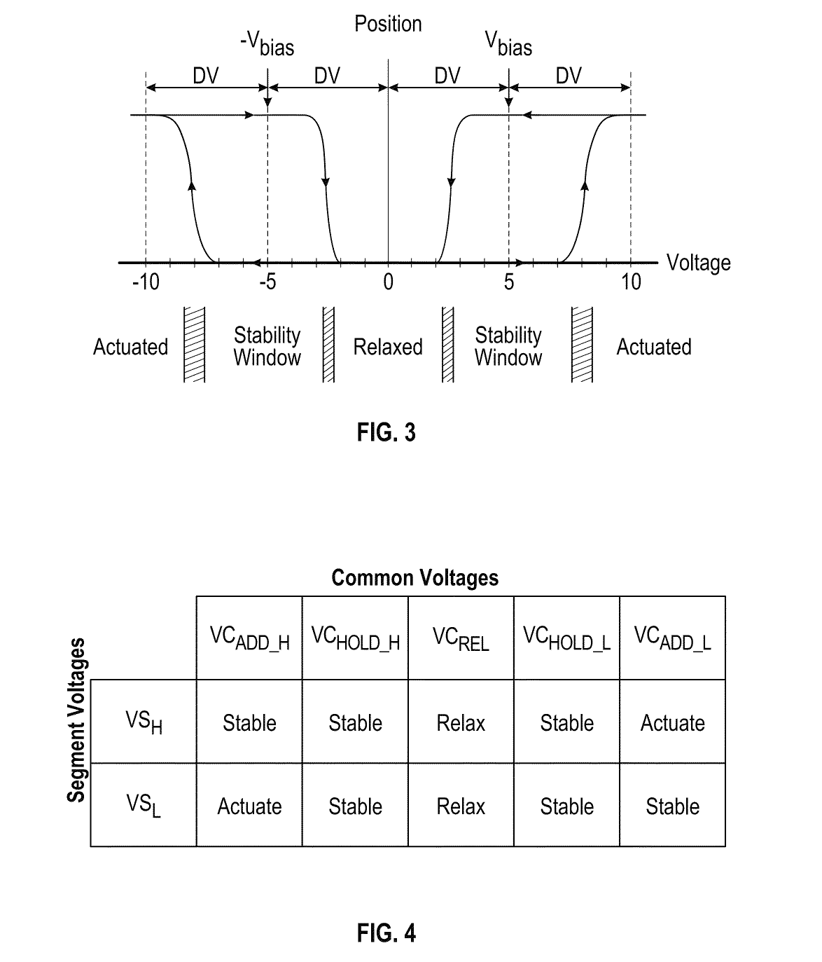

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

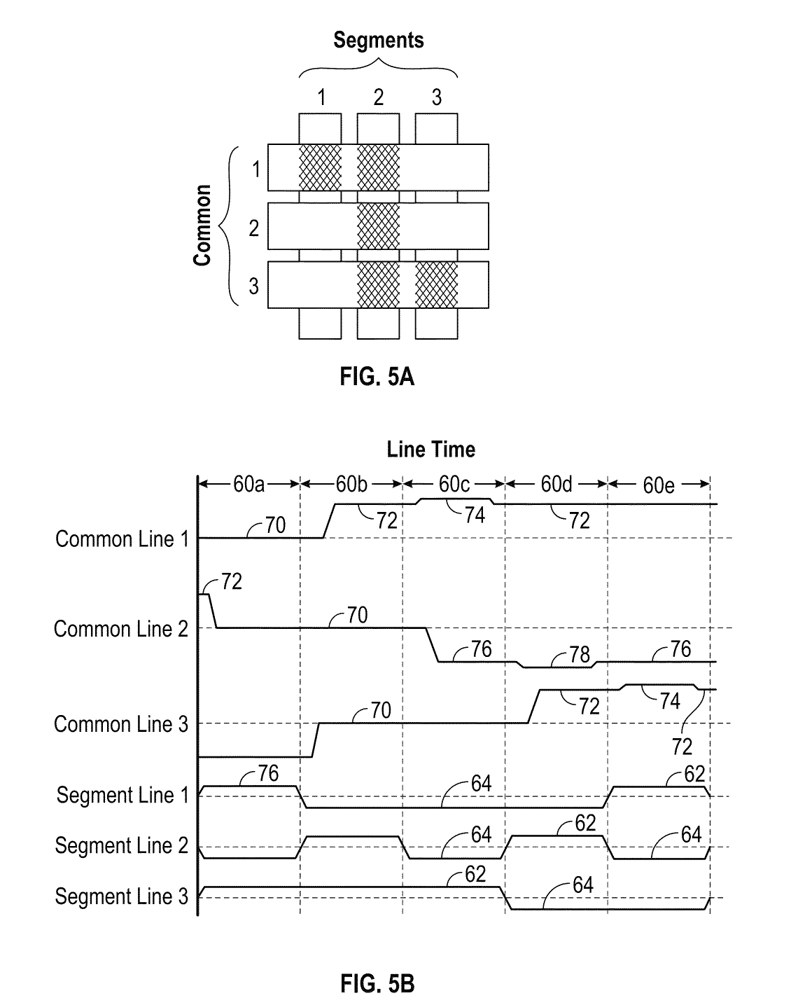

FIG. 3 is a graph illustrating movable reflective layer position versus applied voltage for an IMOD display element. For IMODs, the row/column (i.e., common/segment) write procedure may take advantage of a hysteresis property of the display elements as illustrated in FIG. 3. An IMOD display element may use, in one example implementation, about a 10-volt potential difference to cause the movable reflective layer, or mirror, to change from the relaxed state to the actuated state. When the voltage is reduced from that value, the movable reflective layer maintains its state as the voltage drops back below, in this example, 10 volts, however, the movable reflective layer does not relax completely until the voltage drops below 2 volts. Thus, a range of voltage, approximately 3-7 volts, in the example of FIG. 3, exists where there is a window of applied voltage within which the element is stable in either the relaxed or actuated state. This is referred to herein as the “hysteresis window” or “stability window.” For a display array 30 having the hysteresis characteristics of FIG. 3, the row/column write procedure can be designed to address one or more rows at a time. Thus, in this example, during the addressing of a given row, display elements that are to be actuated in the addressed row can be exposed to a voltage difference of about 10 volts, and display elements that are to be relaxed can be exposed to a voltage difference of near zero volts. After addressing, the display elements can be exposed to a steady state or bias voltage difference of approximately 5 volts in this example, such that they remain in the previously strobed, or written, state. In this example, after being addressed, each display element sees a potential difference within the “stability window” of about 3-7 volts. This hysteresis property feature enables the IMOD display element design to remain stable in either an actuated or relaxed pre-existing state under the same applied voltage conditions. Since each IMOD display element, whether in the actuated or relaxed state, can serve as a capacitor formed by the fixed and moving reflective layers, this stable state can be held at a steady voltage within the hysteresis window without substantially consuming or losing power. Moreover, essentially little or no current flows into the display element if the applied voltage potential remains substantially fixed.

In some implementations, a frame of an image may be created by applying data signals in the form of “segment” voltages along the set of column electrodes, in accordance with the desired change (if any) to the state of the display elements in a given row. Each row of the array can be addressed in turn, such that the frame is written one row at a time. To write the desired data to the display elements in a first row, segment voltages corresponding to the desired state of the display elements in the first row can be applied on the column electrodes, and a first row pulse in the form of a specific “common” voltage or signal can be applied to the first row electrode. The set of segment voltages can then be changed to correspond to the desired change (if any) to the state of the display elements in the second row, and a second common voltage can be applied to the second row electrode. In some implementations, the display elements in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

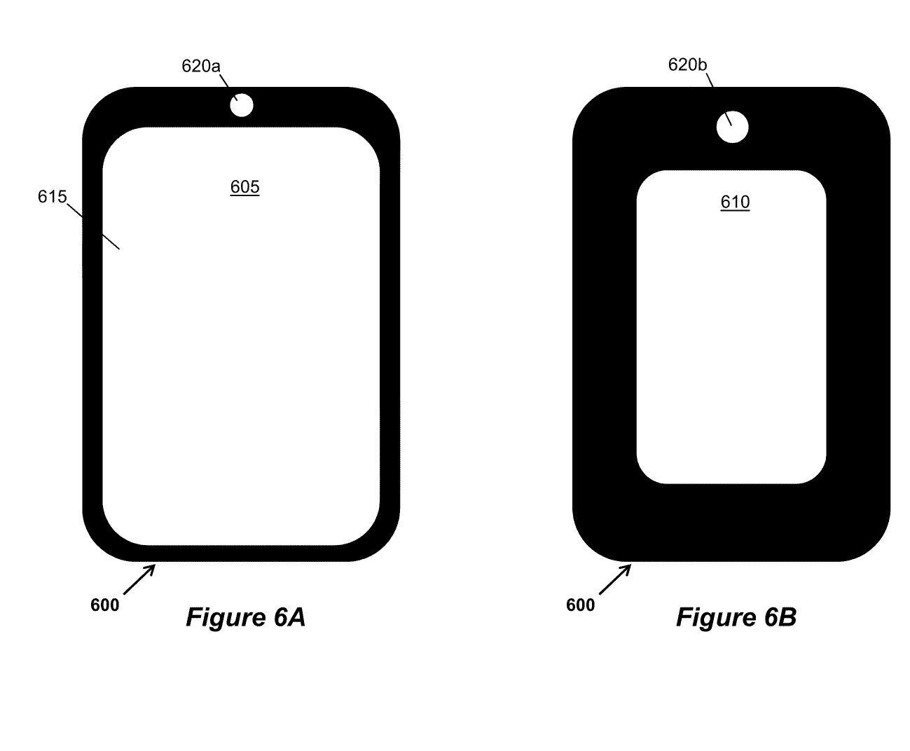

The combination of segment and common signals applied across each display element (that is, the potential difference across each display element or pixel) determines the resulting state of each display element. FIG. 4 is a table illustrating various states of an IMOD display element when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

As illustrated in FIG. 4, when a release voltage VC_{REL} is applied along a common line, all IMOD display elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator display elements or pixels (alternatively referred to as a display element or pixel voltage) can be within the relaxation window (see FIG. 3, also referred to as a release window) both when the high segment voltage VS_{H} and the low segment voltage VS_{L} are applied along the corresponding segment line for that display element.

When a hold voltage is applied on a common line, such as a high hold voltage VC_{HOLD}_{_{—}}_{H} or a low hold voltage VC_{HOLD}_{_{—}}_{L}, the state of the IMOD display element along that common line will remain constant. For example, a relaxed IMOD display element will remain in a relaxed position, and an actuated IMOD display element will remain in an actuated position. The hold voltages can be selected such that the display element voltage will remain within a stability window both when the high segment voltage VS_{H} and the low segment voltage VS_{L} are applied along the corresponding segment line. Thus, the segment voltage swing in this example is the difference between the high VS_{H} and low segment voltage VS_{L}, and is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that common line by application of segment voltages along the respective segment lines. The segment voltages may be selected such that actuation is dependent upon the segment voltage applied. When an addressing voltage is applied along a common line, application of one segment voltage will result in a display element voltage within a stability window, causing the display element to remain unactuated. In contrast, application of the other segment voltage will result in a display element voltage beyond the stability window, resulting in actuation of the display element. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having substantially no effect (i.e., remaining stable) on the state of the modulator.

In some implementations, hold voltages, address voltages, and segment voltages may be used which produce the same polarity potential difference across the modulators. In some other implementations, signals can be used which alternate the polarity of the potential difference of the modulators from time to time. Alternation of the polarity across the modulators (that is, alternation of the polarity of write procedures) may reduce or inhibit charge accumulation that could occur after repeated write operations of a single polarity.

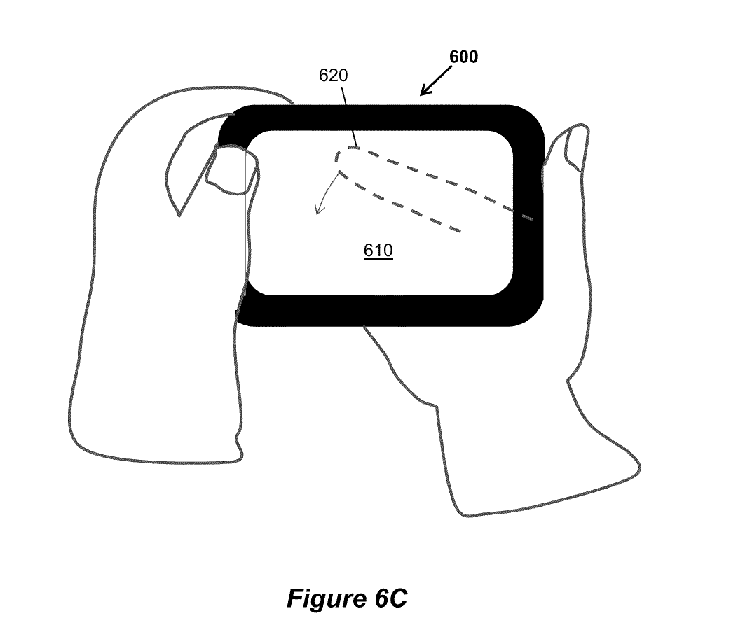

FIG. 5A is an illustration of a frame of display data in a three element by three element array of IMOD display elements displaying an image. FIG. 5B is a timing diagram for common and segment signals that may be used to write data to the display elements illustrated in FIG. 5A. The actuated IMOD display elements in FIG. 5A, shown by darkened checkered patterns, are in a dark-state, i.e., where a substantial portion of the reflected light is outside of the visible spectrum so as to result in a dark appearance to, for example, a viewer. Each of the unactuated IMOD display elements reflect a color corresponding to their interferometric cavity gap heights. Prior to writing the frame illustrated in FIG. 5A, the display elements can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. In some implementations, the segment voltages applied along segment lines 1, 2 and 3 will have no effect on the state of the IMOD display elements, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the display element voltage across modulators (1,1) and (1,2) is greater than the high end of the positive stability window (i.e., the voltage differential exceeded a characteristic threshold) of the modulators, and the modulators (1,1) and (1,2) are actuated. Conversely, because a high segment voltage 62 is applied along segment line 3, the display element voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the display element voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state. Then, the voltage on common line 2 transitions back to the low hold voltage 76.

Finally, during the fifth line time 60e, the voltage on common line 1 remains at high hold voltage 72, and the voltage on common line 2 remains at the low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 display element array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the display element voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5A. In some other implementations, voltages applied along common lines or segment lines may vary to account for variations in the actuation and release voltages of different modulators, such as modulators of different colors.

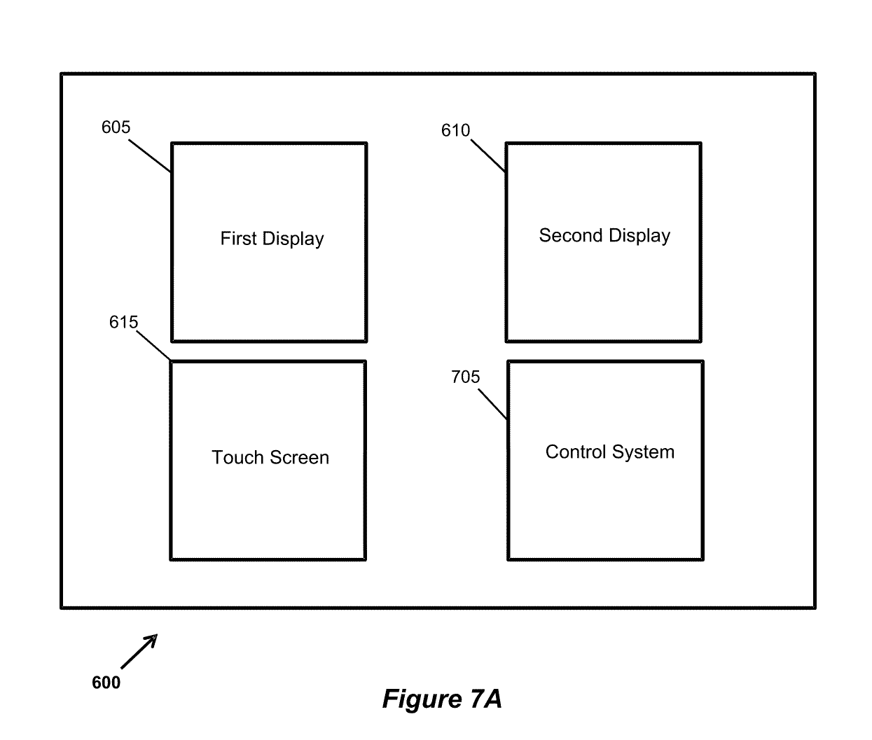

In order to maximize a display area, it may be desirable to increase the amount of surface area of the device on which a display is provided. Therefore, some display devices provided herein may include displays on more than one side of a display device. For example, some display devices may have a first or primary display and at least one other display, which will be referred to herein as a secondary or second display. The primary display may be on one side of the device and the secondary display may be on another side of the device. The second display may be a reflective display, such as an IMOD display, which may consume less power than the primary display. Some such display devices will now be described with reference to FIG. 6A et seq.

FIGS. 6A and 6B show an example of a display device having a first display and a second display. As shown in FIG. 6A, in this example the display device 600 includes a first display 605 having a touch screen 615 disposed thereon. Both the first display 605 and the touch screen 615 may be disposed on the same side of the display device 600, which may be referred to herein as the “first side” or the “front.”

As shown in FIG. 6B, in this example the display device 600 also includes a second display 610. In this implementation, the second display 610 is disposed on another side of the display device 600, which may be referred to herein as the “second side” or the “back.” In alternative implementations, the second display 610 may be disposed on another part of the display device 600. For example, the display device 600 may include two or more portions connected by a hinge or another such device, e.g., in a “clamshell” configuration. The first device 605 may be disposed on a first portion of the display device 600 and the second display 610 may be disposed on another portion of the display device 600.

The second display 610 may consume less power than the first display 605. For example, the first display 605 may be an emissive or a transmissive display, such as an OLED-based display or an LCD-based display, whereas the second display may be a reflective display. In some implementations, the second display 610 may be an IMOD display, an electrofluidic display, an electrophoretic display or a display based on electro-wetting technology.

In this example, the display device 600 also includes a camera system 620. Here, the camera 620a is disposed on the front of the display device 600 and the camera 620b is disposed on the back of the display device 600.

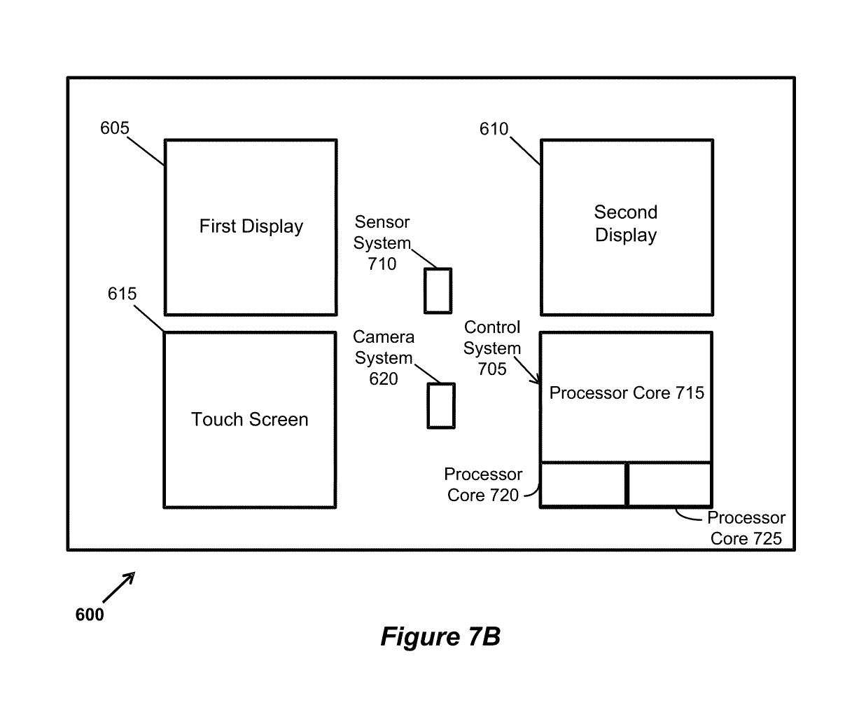

FIG. 7A is a block diagram that shows components of a display device 600 according to one implementation. In the implementation shown in FIG. 7A, the display device 600 includes a first display 605 and an associated touch screen 615. In some implementations, the touch screen 615 may be disposed directly over the first display 605. In this example, the display device 600 includes a second display 610 that does not have a touch screen disposed thereon.

The control system 705 may include at least one of a general purpose single- or multi-chip processor, a digital signal processor (DSP), an application specific integrated circuit (ASIC), a field programmable gate array (FPGA) or other programmable logic device, discrete gate or transistor logic, or discrete hardware components. In some implementations, the control system may comprise a “system on a chip” that includes a general-purpose processor and one or more other DSPs, ASICs FPGAs and/or other logic devices. However, all of the elements of the control system 705 may or may not be in the same area of the display device 600, depending on the particular implementation. For example, in some implementations the control system 705 may include a processor in one location and a touch controller in another location.

The control system 705 may be configured to control the first display 605, the second display 610 and the touch screen 615. The control system 705 may be configured to control the second display 610 in response to input received from the touch screen 615, even when the first display 605 is powered off.

For example, the control system 705 may be configured to switch the first display 605 off when controlling the second display 610 in response to input received from the touch screen 615. As noted above, the first display 605 and the second display 610 may be on opposite sides of the display device 600. Therefore, when a user is viewing the second display 610, the first display 605 may be powered off with no detriment to the user's experience.

However, the touch screen 615 may still be powered on during at least some such times. The user may interact with content displayed on the second display 610 by providing taps, swipes or other gestures, etc., to the touch screen 615. In some implementations, the display device may be configured such that a user's input to the touch screen 615 (or another input device) will indicate to the control system whether to control the first display 605 or the second display 610 in response to further input received from the touch screen 615.

FIG. 6C shows an example of a user interacting with a touch screen. In this example, the user is holding the display device 600 in a position that allows the second display 610 to be viewed. A finger 620 of the user is interacting with a touch screen 615 on the first display 605, which is on the opposite side of the display device 600 from the side on which the second display 610 is disposed. In this example, the user is interacting with the touch screen 615 via a finger swipe. However, in some implementations, the touch screen 615 may be configured to receive user input via a number of single-touch and/or multi-touch gestures, such as tap, double tap, long press, scroll, pan, flick, two-finger tap, two-finger scroll, pinch, spread and rotate. In this example, the first display 605 is not facing the viewer and may be powered off.

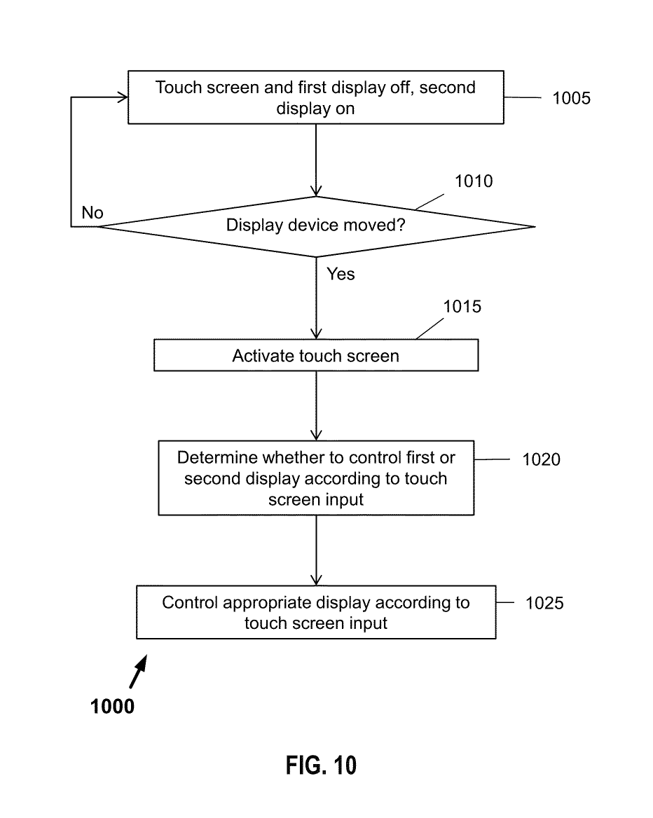

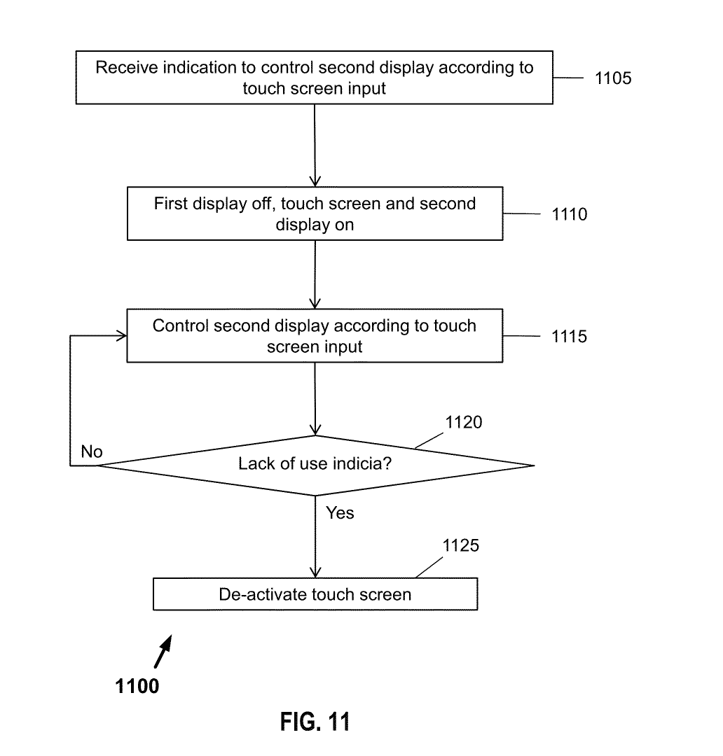

FIG. 7B is a block diagram that shows components of a display device 600 according to an alternative implementation. In this example, the display device 600 includes a camera system 620 and a sensor system 710. In some implementations, the control system 705 may be configured to control the touch screen 615, the first display 605 and/or the second display 610 based on the occurrence (or non-occurrence) of certain events, at least some of which may be determined according to sensor data from the sensor system 710. In some such implementations, the control system 705 may be configured to activate or de-activate the touch screen 615, the first display 605 and/or the second display 610 based on sensor data from the sensor system 710. Some examples are described below with reference to FIGS. 10 and 11.

In the example shown in FIG. 7B, the control system 705 includes processor cores 715, 720 and 725. As noted above, the control system 705 also may include other elements that are not shown in FIG. 7B. Some of the processor cores of the control system 705 may consume relatively more power than others. In this example, the processor core 715 is a higher-power processor core and processor cores 720 and 725 are lower-power processor cores. In various implementations, processor core 715 may include one or more higher-power processor cores and processor cores 720 and 725 include one or more lower-power processor cores. For example, the processor core 715 may be an applications processor core. In some implementations, the control system 705 may include a processor of the Qualcomm Snapdragon™ family of processors, such as a MSM8960 processor or a similar processor. The processor core 720 and/or 725 may be lower-power processor cores, such as the ARM 7 core of a Qualcomm MSM8960 processor.

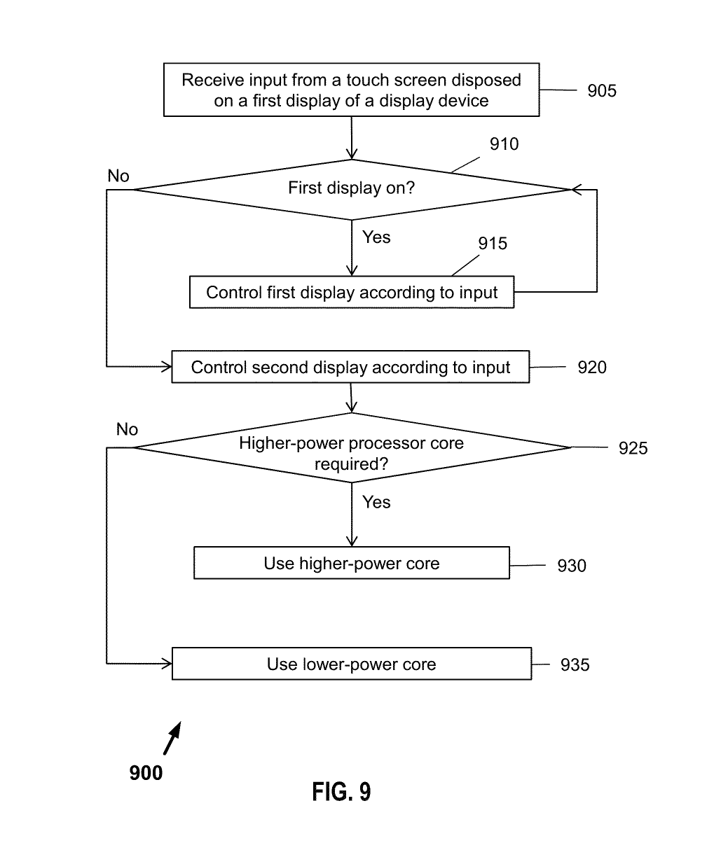

Some implementations described herein may involve establishing communication between the touch screen 615 and either a higher-power processor core or a lower-power processor core, according to one or more criteria. Some examples are described below with reference to FIG. 9.

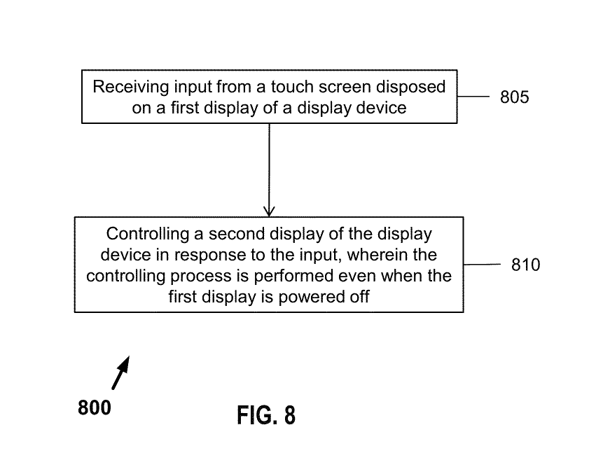

FIG. 8 is a flow diagram that outlines a method of controlling a display device. The display device may include a first display, a second display, a touch screen mounted on the first display and a control system configured to control the first display, the second display and the touch screen.

In this example, block 805 involves receiving input from a touch screen disposed on the first display of the display device. Block 810 involves controlling the second display of the display device in response to the input. The controlling process may be performed even when the first display is powered off. In some implementations, the display device may be substantially similar to the display device 600 shown in FIGS. 6A-6C. For example, block 805 may involve receiving input in a manner similar to that shown in FIG. 6C, wherein the second display 610 is on a first side of the display device 600 facing the user and the user interacts with a touch screen on the opposite side of the display device 600.

However, the method 800 may be performed by display devices having other configurations. For example, the method 800 may be performed by devices having the first display and the touch screen included in a first display portion that is connected for rotation (for example, by a hinge) to a second display portion that includes the second display. Such devices include, but are not limited to, “clamshell” mobile devices, laptop computers, tablet devices, etc. In such implementations, the touch screen and the second display may both be visible to the user when the method 800 is performed.

FIG. 9 is a flow diagram that outlines an alternative method of controlling a display device. The display device may include a first display, a second display, a touch screen mounted on the first display and a control system configured to control the first display, the second display and the touch screen.

In this example, block 905 involves receiving input from the touch screen disposed on the first display of the display device. Block 910 involves determining (for example, by the control system) whether the first display is on. If it is determined in block 910 that the first display is on, in block 915 the first display may be controlled according to input from the touch screen. In some implementations, the control system may be configured to control the first display in response to input received from the touch screen when the first display is switched on and/or when the second display is off or not in use. In this example, if it is determined in block 910 that the first display is off and the second display is on, in block 920 the second display may be controlled according to input from the touch screen.

In this implementation, the control system includes a higher-powered processor core (such as an applications processor core) and at least one lower-powered processor core. For example, the display device may be configured substantially as shown in FIG. 7B, wherein the control system 705 includes processor cores 715, 720 and 725. In other implementations, the control system 705 may include more or fewer processor cores and/or may include other elements that are not shown in FIG. 7B.

In block 925, it is determined whether the higher-power processor core is required. In some such implementations, the control system 705 may be configured to turn the applications processor core on or off according to a type of application that is being used to control the second display 610. For example, if a gaming application is being run and corresponding graphics are being shown on the second display, the control system may be configured to turn an applications processor core on in block 930 and to execute the gaming application on the applications processor core, according to input received from the touch screen. The relatively higher power consumption of the applications processor core is justifiable in this context, given the higher processing speed and graphical requirements of applications such as gaming applications. Communication between the applications processor core and the touch screen may be established.

If the second display is being used to display incoming text messages, the time of day, the weather, etc., in block 935 the control system may be configured to turn the applications processor off and to run the required applications on one or more of the lower-power processor cores, according to input received from the touch screen. Accordingly, the display device may be operated in a mode that consumes relatively less power when a higher-power processor core is not required for the application(s) currently in use. Communication between the lower-power processor core and the touch screen may be established.

FIG. 10 is a flow diagram that outlines another method of controlling a display device. As with the previously-described methods, the display device may include a first display, a second display, a touch screen mounted on the first display and a control system configured to control the first display, the second display and the touch screen. For example, the display device may be substantially similar to the display device 600 shown in FIG. 7B. In some implementations, the sensor system 710 (see FIG. 7B) may include a motion sensor. In some implementations, the sensor system 710 may include an orientation sensor, such as a gyroscope system, a magnetometer and/or a proximity sensor. In some implementations, a control system may use a combination of input from one or more of an accelerometer, a gyroscope and/or a magnetometer (also known as 6-axis or 9-axis fusion), or their inputs individually, to make relevant decisions.

In this example, the method 1000 begins with the touch screen and the first display off, and the second display on. For example, a user may have set the display device 600 down with the first display 605 facing down and the second display 610 facing up. In some implementations, the sensor system 710 may be configured to detect a surface adjacent to the first display 605. Based on orientation and/or proximity data from the sensor system 710 (and/or based on lack of use for a predetermined time), the control system 705 may be configured to switch off the first display 605 and/or the touch screen 615. However, the control system 705 may be configured to leave the second display 610 on, at least for another predetermined period of time, because the user may still wish to view the second display 610 when the display device 600 is in this position.

In block 1010, it is determined whether the display device has been moved. For example, the determination of block 1010 may be made by a control system in response to sensor data received from the sensor system 710. In some implementations, the control system 705 may receive sensor data based on an interrupt. For example, the control system 705 may receive sensor data based on an interrupt when motion detected by the sensor system 710 is greater than a predetermined magnitude. Such implementations may save power on the part of the control system. If it is determined in block 1010 that the display device has not been moved, the touch screen and the first display will remain off.

However, in this example, if it is determined in block 1010 that the display device has been moved, the touch screen will be activated in block 1015. In block 1020, it is determined whether the touch screen will provide input for controlling the first display or the second display. In some implementations, block 1020 may be performed in response to input received from a user via the touch screen or via another user input mechanism.

Alternatively, or additionally, block 1020 may be performed in response to input received from an orientation sensor. For example, at the time of block 1005, the display device may be in a stationary position on a surface with the first display facing down, and may subsequently be moved. A user may, for example, have been viewing the second display while the display device was resting on the surface.

If the user picks up the display device and keeps the display device in substantially the same orientation (in this example, with the second display facing up), this may be an indication that the user wants to interact with what is being displayed on the second display. For example, the user may be lifting the display device in response to an incoming text or email message, a news headline, information received via a social media application, etc. Therefore, it may be determined in block 1020 (for example, by a control system in response to sensor data received from a sensor system) that the touch screen will provide input for controlling the second display.

However, if the display device is lifted and rotated, the user may be positioning the display device so that the first display is viewable. Therefore, it may be determined in block 1020 that the touch screen will provide input for controlling the first display. In block 1025, the appropriate display may be controlled according to touch screen input and possibly other input (for example, according to voice commands from a user received by a microphone and relayed to the control system).

If block 1025 involves controlling the first display according to input from the touch screen, some implementations may include a process of evaluating subsequent use of the touch screen, subsequent orientation of the display device, etc. For example, in some implementations, the control system may be configured to deactivate the first display and/or the touch screen if the control system receives no indication from the motion sensor that the apparatus has been moved for a predetermined period of time. Alternatively, or additionally, the control system may be configured to deactivate the first display and/or the touch screen if the control system receives an indication from the sensor system that the display device has been oriented with the first display facing down, or if the control system receives no indication that the touch screen has been used for a period of time. Some examples of the latter functionality will now be described with reference to FIG. 11.

FIG. 11 is a flow diagram that outlines a method of controlling a display device according to use indicia. As with the previously-described methods, the display device may include a first display, a second display, a touch screen mounted on the first display and a control system configured to control the first display, the second display and the touch screen. In this example, the method 1100 begins with the receipt of an indication that the touch screen will be used to control the second display. For example, the indication may be received according to input from a user. Alternatively, the indication may be received according to input from a sensor system, for example as described above with reference to FIG. 10.

Accordingly, in this example the first display is switched off at a time corresponding to block 1110, whereas the touch screen and the second display are powered on. In block 1115, the second display may be controlled according to input from the touch screen and possibly according to other input devices.

In this implementation, use indicia are evaluated in block 1120. If the touch screen continues to be used, in this example the second display will continue to be controlled according to input from the touch screen in block 1115. However, in block 1125 the control system may be configured to deactivate the touch screen if the control system receives no indication from the motion sensor that the apparatus has been moved for a predetermined period of time. Alternatively, or additionally, the control system may be configured to deactivate the touch screen if the control system receives no indication that the touch screen has been used for a period of time.

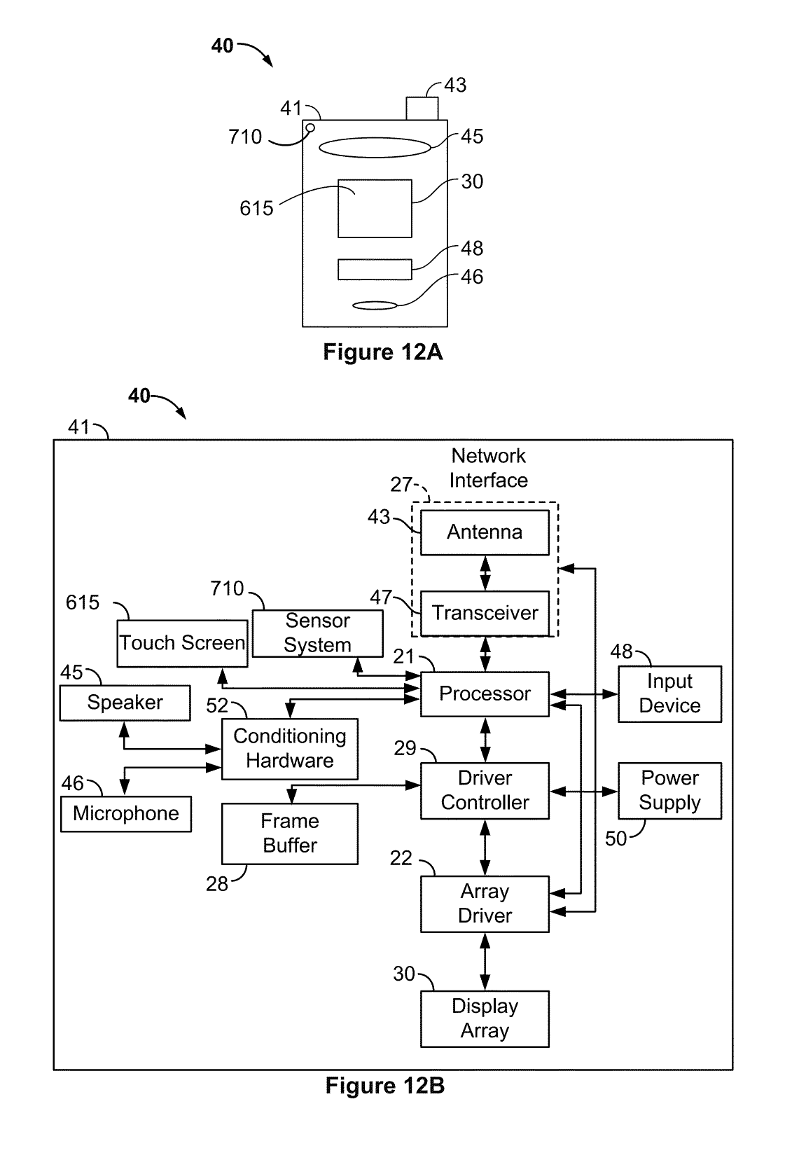

FIGS. 12A and 12B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

In this example, the display device 40 includes a housing 41, a display system 30, an antenna 43, a speaker 45, an input device 48, a touch screen 615, a sensor system 715 and a microphone 46. One portion of the sensor system 710, which may be a proximity sensor, is illustrated in FIG. 12A. In some implementations, the sensor system 710 also may include one or more motion sensors, orientation sensors, or other sensors. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display system 30 may include any of a variety of displays, including a bi-stable or analog display, as described herein. In various implementations described herein, the display system 30 includes a primary display and a secondary display as described above. For example, the primary display may be a flat-panel display, such as plasma, EL, OLED, STN LCD, or TFT LCD, or a non-flat-panel display, such as a CRT or other tube device. In this example, the touch screen 615 is disposed on the primary display. The secondary display system may be a lower-power reflective display, for example, an IMOD-based display, as described herein. The secondary display is not visible in FIG. 12A, because it is on the opposite side of the display device 40 from the primary display and the touch screen 615.

The components of the display device 40 are schematically illustrated in FIG. 12A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 12A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. For example, the processor 21 (or another component of a control system) may be configured to perform, at least in part, the methods described herein. For example, the processor 21 may be configured to determine whether to control the primary display or the secondary display according to input from the touch screen 615. This determination may be based, at least in part, on sensor data received from the sensor system 710. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a non-transitory computer-readable medium. The steps of a method or algorithm disclosed herein may be implemented in a processor-executable software module which may reside on a non-transitory computer-readable medium. Computer-readable media include both computer storage media and communication media including any medium that can be enabled to transfer a computer program from one place to another. A storage medium may be any available medium that may be accessed by a computer. By way of example, and not limitation, non-transitory computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

For example, the rear camera on a smart phone is usually more powerful (for example, having more megapixels and a higher resolution) than the front-facing camera. Therefore, many users prefer using the rear camera for taking self-portraits. However, users often become frustrated when attempting to frame the picture correctly, because they do not normally have a “viewfinder” display on the back of the phone.

Various implementations described herein have a second display on the back of a smart phone, which may be used as a “viewfinder” display. Such implementations allow the user to preview a self-portrait that he/she is taking on the second display. If the user wants to make changes to the self-portrait (such as “cropping” or other editing) before saving the image, some implementations allow a user to make such changes while the image is being displayed on the second display. In some such implementations, a user may use a touch screen disposed on the first display. Such implementations may be particularly advantageous for implementations wherein the second display is much smaller than the first display, because including a separate touch screen on the second display may not be practical.

In some implementations, the “touchable” area within the first display may be automatically and contextually configured according to the application that is invoked on the second display. For example, if a game that is being played on the second display wherein the touch-points are limited to the center of the screen, such control may be set automatically on the touch controller of the first display, so that irrelevant points of the touch screen or touchable area are not inadvertently actuated. Such control may prevent undesired outcomes.

Additionally, other implementations may be within the scope of the following claims. In some cases, the actions recited in the claims can be performed in a different order and still achieve desirable results.

What is claimed is:

1. An apparatus, comprising:
a first display;
a touch screen disposed on the first display;
a second display; and
a control system configured to control the second display in response to input received from the touch screen even when the first display is powered off.

2. The apparatus of claim 1, wherein the control system is configured to switch the first display off when controlling the second display in response to input received from the touch screen.

3. The apparatus of claim 1, wherein the first display is disposed on a first side of the apparatus and the second display is disposed on a second side of the apparatus.

4. The apparatus of claim 3, wherein the first side is on an opposite side of the apparatus relative to the second side.

5. The apparatus of claim 1, wherein the second display consumes less power than the first display.

6. The apparatus of claim 1, wherein the second display is a reflective display.

7. The apparatus of claim 6, wherein the reflective display is an interferometric modulator (“IMOD”) display.

8. The apparatus of claim 1, wherein the first display is an emissive or a transmissive display.

9. The apparatus of claim 1, wherein the control system is further configured to control the first display in response to input received from the touch screen when the first display is switched on or when the second display is not in use.

10. The apparatus of claim 1, wherein the control system includes a higher-power processor core, wherein the control system is further configured to turn the higher-power processor core on or off according to a type of application that is being used to control the second display.

11. The apparatus of claim 1, wherein the control system includes a lower-power processor core and a higher-power processor core, wherein the control system is further configured to determine whether to use the higher-power processor core or the low-power processor core to control at least part of the apparatus.

12. The apparatus of claim 1, further comprising a motion sensor, wherein the control system is further configured to activate the touch screen if the control system receives an indication from the motion sensor that the apparatus has been moved from a stationary position.

13. The apparatus of claim 12, wherein the control system is further configured to deactivate the touch screen if the control system receives no indication that the apparatus has been moved, or that the touch screen has been used, for a period of time.

14. The apparatus of claim 1, further comprising an orientation sensor, wherein the control system is further configured to activate or deactivate the first display according to input from the orientation sensor.

15. The apparatus of claim 1, wherein the control system is configured to process image data.

16. The apparatus of claim 15, wherein the control system further comprises:
a driver circuit configured to send at least one signal to at least one of the first display or the second display; and
a controller configured to send at least a portion of the image data to the driver circuit.

17. The apparatus of claim 15, wherein the control system further comprises:
an image source module configured to send the image data to the processor, wherein the image source module includes at least one of a receiver, transceiver, and transmitter.

18. The apparatus of claim 15, further comprising:
an input device configured to receive input data and to communicate the input data to the control system.

19. The apparatus of claim 1, wherein the control system is further configured to map touch screen areas to second display areas.

20. The apparatus of claim 19, wherein the size of the touch screen is different from the size of the second display.

21. The apparatus of claim 1, wherein the control system includes at least one of a general purpose single- or multi-chip processor, a digital signal processor (DSP), an application specific integrated circuit (ASIC), a field programmable gate array (FPGA) or other programmable logic device, discrete gate or transistor logic, or discrete hardware components.

22. The apparatus of claim 21, wherein the control system includes a system on a chip that includes the general purpose single- or multi-chip processor and one or more of the DSP, ASIC, FPGA or other programmable logic device, discrete gate or transistor logic, or discrete hardware components.

23. A method, comprising:
receiving input from a touch screen disposed on a first display of a display device; and
controlling a second display of the display device in response to the input, wherein the controlling process is performed even when the first display is powered off.

24. The method of claim 23, wherein the display device includes a higher-power processor core, further comprising:
determining a type of application that is being used to control the second display; and
turning the higher-power processor core on or off according to the type of application.

25. The method of claim 23, wherein the display device includes a low-power processor core and a higher-power processor core, and wherein the method includes determining whether to use the higher-power processor core or the low-power processor core to control at least part of the display device.

26. The method of claim 23, wherein the display device includes a motion sensor and wherein the method includes activating the touch screen if the motion sensor indicates that the display device has been moved from a stationary position.

27. The method of claim 23, wherein the display device includes an orientation sensor and wherein the method includes activating or deactivating the first display according to input from the orientation sensor.

28. The method of claim 23, further including mapping touch screen areas to second display areas.

29. The method of claim 28, wherein the first display is on an opposite side of the display device relative to the second display.

30. A non-transitory medium having instructions for the following processes stored thereon:
receiving input from a touch screen disposed on a first display of a display device; and
controlling a second display of the display device in response to the input, wherein the controlling process is performed even when the first display is powered off.

31. The non-transitory medium of claim 30, wherein the display device includes a higher-power processor core, wherein the medium includes instructions for:
determining a type of application that is being used to control the second display; and
turning the higher-power processor core on or off according to the type of application.

32. The non-transitory medium of claim 30, wherein the display device includes a low-power processor core and a higher-power processor core, and wherein the medium includes instructions for determining whether to use the higher-power processor core or the low-power processor core to control at least part of the display device.

33. The non-transitory medium of claim 30, wherein the display device includes a motion sensor and wherein the medium includes instructions for activating the touch screen if the motion sensor indicates that the display device has been moved from a stationary position.

34. The non-transitory medium of claim 30, wherein the display device includes an orientation sensor and wherein the medium includes instructions for activating or deactivating the first display according to input from the orientation sensor.

35. The non-transitory medium of claim 30, wherein the medium includes instructions for mapping touch screen areas to second display areas.
